(19) United States
(12) Patent Application Publication
(10) Pub. No.: US 2026/0065212 A1
(43) Pub. Date: Mar. 5, 2026

(54) INFORMATION PROCESSING APPARATUS AND INFORMATION PROCESSING METHOD

(71) Applicant: Hitachi, Ltd., Tokyo (JP)

(72) Inventors: Keita MIZUSHINA, Tokyo (JP); Tsunehiko BABA, Tokyo (JP); Mika TAKATA, Tokyo (JP)

(21) Appl. No.: 19/211,952

(22) Filed: May 19, 2025

(30) Foreign Application Priority Data
Aug. 30, 2024 (JP) 2024-150216

(51) Int. Cl. G06Q 10/08; G06Q 10/0631; G06Q 10/0875; G06Q 50/04

(52) U.S. Cl. CPC G06Q 10/08; G06Q 10/06315; G06Q 10/0875; G06Q 50/04

(57) ABSTRACT

An information processing apparatus includes: a transaction relationship score calculation unit that calculates an inter-industry transaction relationship score indicating a relevance of a transaction relationship among a plurality of industry types; a component supplier industry-type estimation unit that estimates an industry type of a factory candidate of a supplier on a basis of identification information of a component for a factory candidate of a supplier; an industry type similarity calculation unit that calculates an inter-industry transaction relationship score between an industry type of a factory candidate of a supplier and an industry type of a factory candidate of a supplier estimated by the component supplier industry-type estimation unit; and a component manufacturing factory estimation unit that selects a factory candidate of a supplier on a basis of an inter-industry transaction relationship score calculated by the industry type.

### CROSS-REFERENCE TO RELATED APPLICATION

The present application claims priority from Japanese application JP2024-150216, filed on Aug. 30, 2024, the content of which is hereby incorporated by reference into this application.

### BACKGROUND OF THE INVENTION

### 1. Field of the Invention

The present invention relates to an information processing apparatus and an information processing method. The present invention particularly relates to an information processing apparatus or the like that estimates a location of a component manufacturing factory manufactured by a supplier.

### 2. Description of the Related Art

In order to grasp the supply chain, a supplier list may be created as a list of suppliers that manufacture and supply components and the like. In the current supplier list, for example, a supplier name, a base, and a component name/model number are described as the information of the supplier, but a location of a manufacturing factory of the supplier is often unknown.

JP 2023-147907 A discloses a recommendation apparatus that recommends a company that is a business partner candidate. In this apparatus, an open data collection unit collects, as open data, publicly available or sold company information regarding a business partner candidate company, and registers the company information in a corporate master. The business rule conversion unit collects compliance policies, ESG policies, sales and purchase policies, policies, regulations, and the like of a business entity company, formulates each collected information, and registers the formulated information in the business rule master. The event evaluation unit registers the evaluation result for each evaluation axis for the business partner company in the evaluation master with reference to the business rule master on the basis of the past transaction result information and the external evaluation data collected by the event information collection unit. When there is a recommendation request for a business partner company, the corporation recommendation unit presents a company that can be recommended as a business partner with reference to the corporate master, the evaluation master, and the business rule master.

JP 2023-159850 A discloses a disaster risk management system including a server capable of communicating with a user terminal of a company, and a risk information extraction unit that detects and extracts risk information indicating risk contents including a disaster, an accident, and the like from information collected from an information source including an SNS. The server acquires risk information from the risk information extraction unit, specifies a supplier affected by the risk information using the risk information and the stored supplier company information database and supplier product information database, generates an alert notification including content of the risk information, company information of the specified supplier, supply chain information to which the specified supplier belongs, and product information of the specified supplier, and transmits the alert notification to the user terminal.
Patent Literature 1: JP 2023-147907 A
Patent Literature 2: JP 2023-159850 A

### SUMMARY OF THE INVENTION

For example, in order to evaluate the risk to the supply chain, it is necessary to grasp the location of the manufacturing factory of the component manufactured by the supplier. Conventionally, it is necessary to collect information by a human-wave strategy and specify the information, and enormous man-hours are required for information collection.

An object of the present invention is to provide an information processing apparatus and an information processing method capable of estimating a location of a manufacturing factory of a component manufactured by a supplier.

In order to solve the above problem, the present invention is an information processing apparatus including: a transaction relationship score calculation unit that calculates an inter-industry transaction relationship score indicating a relevance of a transaction relationship among a plurality of industry types; a component supplier industry-type estimation unit that estimates an industry type of a factory candidate of a supplier on a basis of identification information of a component for a factory candidate of a supplier; an industry type similarity calculation unit that calculates an inter-industry transaction relationship score between an industry type of a factory candidate of a supplier and an industry type of a factory candidate of a supplier estimated by the component supplier industry-type estimation unit; and a component manufacturing factory estimation unit that selects a factory candidate of a supplier on a basis of an inter-industry transaction relationship score calculated by the industry type similarity calculation unit, and estimates a location of the selected supplier candidate as a location of a manufacturing factory of a component manufactured by a supplier. In this case, it is possible to provide the information processing apparatus capable of estimating the location of the manufacturing factory of the component manufactured by the supplier.

Here, for example, the transaction relationship score calculation unit narrows down the factory candidates of the supplier by the inter-industry transaction relationship score between the industry type of the company to which the user belongs and the industry type of the factory candidate of the supplier, and sets the narrowed-down factory candidate as a processing target of the component supplier industry-type estimation unit. In this case, it is possible to narrow down the factory candidates of the supplier by focusing on the point that the industry types of the companies having a transaction relationship in the supply chain are similar.

In addition, for example, an industry type estimation unit that estimates an industry type of a factory candidate of a supplier is further provided. In this case, the industry types can be compared on the same evaluation axis.

Further, for example, the component supplier industry-type estimation unit performs at least one of direct estimation of an industry type of a factory candidate of a supplier from at least one of a component name and a model number and estimation via mapping to data of a different system. In this case, the estimation can be performed by combining a plurality of pieces of data based on the component name/model number.

Furthermore, for example, a component/model number estimation unit that acquires component information is further provided. In a case where the component supplier industry-type estimation unit can acquire the component information, the component supplier industry-type estimation unit directly estimates an industry type of a factory candidate of a supplier from at least one of a component name and a model number, and in a case where the component supplier industry-type estimation unit cannot acquire the component information, the component supplier industry-type estimation unit performs estimation via mapping to data of a different system. In this case, even when the industry type of the factory candidate of the supplier cannot be directly estimated on the basis of the component name/model number, it can be estimated by another method.

For example, the data of the different system includes an import/export statistical item number. In this case, it is easier to estimate the industry type of the factory candidate of the supplier.

Furthermore, for example, a company information search unit is further provided which searches for a factory candidate of a supplier on a basis of a supplier list that is a list of information associated with a supplier of a product manufactured by a company to which a user belongs. In this case, it is possible to acquire factory candidates of the supplier using the supplier list. Furthermore, for example, the company information search unit searches for a factory candidate of a supplier by searching for a company name of the supplier included in the supplier list as a keyword. In this case, it is easier to acquire the factory candidates of the supplier by the search.

Furthermore, for example, the company information search unit searches for a factory candidate of a supplier in a case where a supplier included in the supplier list has not acquired public authentication, and estimates an industry type of a factory of a supplier from a manufacturing item registered in the public authentication in a case where the supplier has acquired the public authentication. In this case, in a case where the supplier has acquired the public authentication, the industry type of the factory of the supplier can be estimated on the basis of the public authentication, and even in a case where the supplier has not acquired the public authentication, the company information search unit can search for the factory candidate of the supplier to estimate the industry type of the factory of the supplier. Then, for example, the component manufacturing factory estimation unit selects a factory candidate of the supplier having the maximum inter-industry transaction relationship score, and estimates the location of the factory candidate of the selected supplier as the location of the manufacturing factory of the component manufactured by the supplier. In this case, it is possible to present, to the user, the location having the highest possibility as the location of the factory candidate of the supplier.

Furthermore, for example, the component manufacturing factory estimation unit further selects a factory candidate of a supplier equal to or more than a predetermined threshold. In this case, the user is allowed to select a correction candidate even in a case where the estimation result is wrong.

Further, for example, the transaction relationship score calculation unit calculates the inter-industry transaction relationship score on the basis of the transaction amount between the industry types. In this case, a more appropriate numerical value can be obtained as the inter-industry transaction relationship score.

Further, the present invention is an information processing method performed by a processor that executes a program recorded in a memory. The method includes: calculating an inter-industry transaction relationship score indicating the relevance of a transaction relationship between a plurality of industry types; estimating, for a factory candidate of a supplier, an industry type of the factory candidate of the supplier from a component; calculating an inter-industry transaction relationship score between an industry type of a factory candidate of a supplier and the estimated industry type of the factory candidate of the supplier; selecting a factory candidate of a supplier on a basis of the calculated inter-industry transaction relationship score; and estimating a location of the selected supplier candidate as a location of a manufacturing factory of a component manufactured by the supplier. In this case, it is possible to provide an information processing method capable of estimating the location of the manufacturing factory of the component manufactured by the supplier.

According to the present invention, it is possible to provide an information processing apparatus and an information processing method capable of estimating a location of a manufacturing factory of a component manufactured by a supplier.

### BRIEF DESCRIPTION OF THE DRAWINGS

FIG. 1 is a block diagram illustrating an overall configuration of a risk visualization system according to the present embodiment;

FIG. 2 is a table illustrating an example of a data table of a supplier list received as an input from a person in charge of procurement;

FIG. 3 is a table illustrating an example of a search result generated by a company information search unit and using a company name of a supplier as a keyword;

FIG. 4 is a table of a data table for managing information regarding a company to which a person in charge of procurement belongs;

FIG. 5 is a table illustrating an example of a data table of a transaction relationship between industry types;

FIG. 6 is a table illustrating an example of a data table of an inter-industry transaction relationship score;

FIG. 7 is a diagram illustrating a processing flow of a component manufacturing factory location estimation apparatus in the risk visualization system;

FIG. 8 is a diagram illustrating a flowchart of processing of narrowing down factory candidates of a supplier;

FIG. 9 is a diagram illustrating an output result of a transaction relationship score calculation unit;

FIG. 10 is a diagram illustrating an outline of a processing flow of a component supplier industry-type estimation unit;

FIG. 11 is a diagram illustrating details of a processing flow of the component supplier industry-type estimation unit;

FIG. 12 is a diagram illustrating a data table illustrating an estimation result when (a) the industry type is directly estimated by a component name/model number;

FIG. 13 is a diagram illustrating a data table illustrating an estimation result when (b) the industry type is estimated in two stages through mapping from the component name/model number to data of one different system;

FIG. 14 is a diagram illustrating a data table illustrating an estimation result when (c) the industry type is estimated in three stages through mapping from the component name/model number to data of two different systems;

FIG. 15 is a diagram illustrating a data table when the inter-industry transaction relationship score is assigned to the search result of FIG. 3;

FIG. 16 is a diagram illustrating a processing flow of a component manufacturing factory estimation unit; and

FIG. 17 is a diagram illustrating a data table when the location of the component manufacturing factory estimated in S707 of FIG. 7 is reflected in the supplier list.

### DESCRIPTION OF THE PREFERRED EMBODIMENTS

Hereinafter, the present invention will be described using the drawings. However, the invention is not interpreted in a limited way to the following embodiments. A person skilled in the art can easily understand that the specific configurations may be changed within a scope not departing from the ideas and the spirit of the present invention.

In the configuration of the invention described below, the same reference numerals are commonly used for the same portions or portions having similar functions in different drawings, and redundant description may be omitted.

When there are a plurality of elements having the same or similar functions, different subscripts may be given for the same reference numerals for explanation. However, when there is no need to distinguish between a plurality of elements, the description may be omitted with subscripts omitted.

The notations of “first”, “second”, and “third” in this specification are attached in order to identify the components, but not necessarily used to indicate the number, the order, or the contents. In addition, a number for identifying a component is used for each context, and a number used in one context does not necessarily indicate the same configuration in another context. In addition, it does not prevent a component identified by a certain number from also functioning as a component identified by another number.

The position, size, shape, range, and the like of each element illustrated in the drawings and the like may not necessarily represent the actual position, size, shape, range, and the like, in order to facilitate understanding of the invention. For this reason, the present invention is not necessarily limited to the position, size, shape, range, and the like disclosed in the drawings and the like.

### <Outline Description of Risk Visualization System 1>

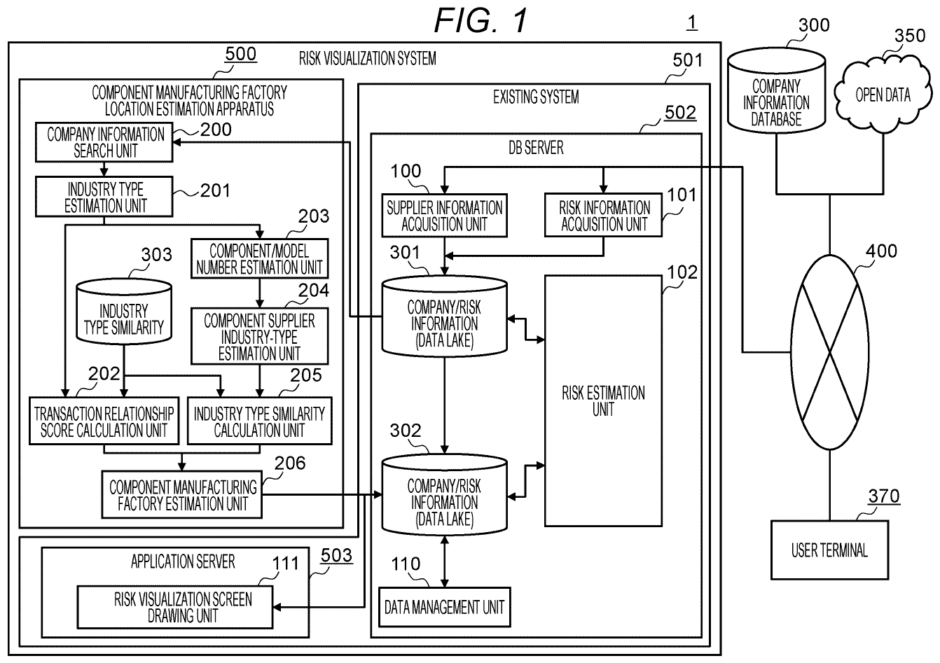

FIG. 1 is a block diagram illustrating an overall configuration of a risk visualization system 1 according to the present embodiment.

FIG. 1 is a system configuration diagram illustrating a case where the present invention is applied to the risk visualization system 1 that visualizes and displays risk information affecting suppliers.

The risk visualization system 1 is connected to a company information database 300, open data 350, and a user terminal 370 via a network 400.

The company information database 300 stores information regarding a company including a supplier.

The open data 350 is public and private data owned by a country, a local public entity, and a business operator, and is data that can be easily used by anyone through the network 400.

The user terminal 370 is a terminal device of the user. The user is, for example, a person in charge of procurement who is a user of the risk visualization system 1. The person in charge of procurement shall perform management for the purpose of stability of the entire supply chain and reduction of loss. The person in charge of procurement may be a member of a management class or a financial department, or may be a member of a company (for example, a consultant company or a subsidiary company) separate from the member.

The network 400 is a communication means used for information communication among the risk visualization system 1, the company information database 300, the open data 350, and the user terminal 370, and is, for example, the Internet, a local area network (LAN), or a wide area network (WAN). The communication line used for the information communication may be wired or wireless, and may be used in combination of wired and wireless. Furthermore, the risk visualization system 1, the company information database 300, the open data 350, and the user terminal 370 may be connected via a plurality of networks or communication lines using a relay device such as a gateway device or a router.

The risk visualization system 1 has a form in which a component manufacturing factory location estimation apparatus 500 is connected to an existing system 501. The existing system 501 is a device that estimates a risk for a supply chain. The existing system 501 includes a database (DB) server 502 that manages data related to a supply chain and evaluates a risk for the supply chain, and an application server 503 that visualizes the risk.

The DB server 502 includes a supplier information acquisition unit 100, a risk information acquisition unit 101, a risk estimation unit 102, company/risk information (data lake) 301, company/risk information (data lake) 302, and a data management unit 110.

The supplier information acquisition unit 100 collects information regarding the supplier from the company information database 300 and the open data 350 via the network 400.

The risk information acquisition unit 101 collects risk information that is data regarding a risk that affects the supply chain. The risk information is, for example, data regarding conflicts, data regarding the production of minerals, oil, and natural gas. Furthermore, the data regarding a risk is, for example, data such as trade statistics, news transmitted from news media, and weather data.

The risk estimation unit 102 estimates a risk for the supply chain and outputs an estimation result. For example, the risk estimation unit 102 calculates a risk degree obtained by quantifying a degree of risk for a type of risk.

The company/risk information (data lake) 301 stores information regarding suppliers collected by the supplier information acquisition unit 100 as a supplier list. The supplier list will be described later in detail. The company/risk information (data lake) 301 stores risk information collected by the risk information acquisition unit 101.

The company/risk information (data lake) 302 acquires data from the company/risk information (data lake) 301, and stores data to which an estimation result of a manufacturing factory of a component manufactured by a supplier is assigned.

The data management unit 110 manages various data handled by the existing system 501.

The application server 503 includes a risk visualization screen drawing unit 111.

The risk visualization screen drawing unit 111 uses the application to visualize the risk estimation result obtained by the risk estimation unit 102 and create an image to be provided to the user.

The component manufacturing factory location estimation apparatus 500 is an example of an information processing apparatus, and estimates a location of a manufacturing factory of a component manufactured by a supplier. The component manufacturing factory location estimation apparatus 500 acquires data from the company/risk information (data lake) 301, and stores the data to which the estimation result of the location of the component manufacturing factory is assigned in the company/risk information (data lake) 302.

The component manufacturing factory location estimation apparatus 500 includes a company information search unit 200, an industry type estimation unit 201, a transaction relationship score calculation unit 202, a component/model number estimation unit 203, a component supplier industry-type estimation unit 204, an industry type similarity calculation unit 205, a component manufacturing factory estimation unit 206, and an industry type similarity 303. As will be described in detail later, these functions are schematically described below.

The company information search unit 200 searches for a factory candidate of a supplier on the basis of the supplier list. At this time, the company information search unit 200 searches for a factory candidate of a supplier by searching for a company name of the supplier included in the supplier list as a keyword.

The industry type estimation unit 201 estimates the industry type of the factory candidate of the supplier.

The transaction relationship score calculation unit 202 calculates an inter-industry transaction relationship score indicating a relevance of a transaction relationship among a plurality of industry types. The transaction relationship score calculation unit 202 calculates the inter-industry transaction relationship score on the basis of the transaction amount between the industry types. As a result, a more appropriate numerical value can be obtained as the inter-industry transaction relationship score. In addition, the transaction relationship score calculation unit 202 narrows down the factory candidates of the supplier by the inter-industry transaction relationship score between the industry type of the company to which the user belongs and the industry type of the factory candidate of the supplier, and sets the narrowed-down factory candidate as a processing target of the component supplier industry-type estimation unit 204. As a result, it is possible to narrow down the factory candidates of the supplier by focusing on the point that the industry types of the companies having a transaction relationship in the supply chain are similar.

The component/model number estimation unit 203 acquires component information. The component/model number estimation unit 203 acquires component information from at least one of a component name and a model number of a component described in the supplier list. The component information corresponds to, for example, a material, a price, a delivery date, and the like.

The component supplier industry-type estimation unit 204 estimates the industry type of the factory candidate of the supplier on the basis of the identification information of the component for the factory candidate of the supplier. The identification information of the component is not particularly limited as long as the identification information can identify the component, but the present embodiment uses at least one of a component name and a model number described in a supplier list.

The industry type similarity calculation unit 205 calculates an inter-industry transaction relationship score between the industry type of the factory candidate of the supplier and the industry type of the factory candidate of the supplier estimated by the component supplier industry-type estimation unit 204.

The component manufacturing factory estimation unit 206 selects a factory candidate of the supplier on the basis of the inter-industry transaction relationship score calculated by the industry type similarity calculation unit 205, and estimates a location of the selected supplier candidate as a location of a manufacturing factory of a component manufactured by the supplier.

The industry type similarity 303 stores the inter-industry transaction relationship scores calculated by the transaction relationship score calculation unit 202 and the industry type similarity calculation unit 205.

The component manufacturing factory location estimation apparatus 500, the DB server 502, and the application server 503 are computers, for example, server computers. However, the present invention is not limited thereto, and may be a personal computer (PC), a mobile computer, a smartphone, a tablet, or the like. Furthermore, a cloud server or the like operating on a cloud may be used.

The component manufacturing factory location estimation apparatus 500, the DB server 502, and the application server 503 include a processor such as a central processing unit (CPU) which is a calculation means, and a main memory which is a storage means. Here, the processor executes various kinds of software such as an OS (basic software) and an application (application software). The main memory is a storage area for storing various kinds of software, data used for execution thereof, and the like. Further, the component manufacturing factory location estimation apparatus 500, the DB server 502, and the application server 503 include, as auxiliary storage devices, a storage such as a hard disk drive (HDD) or a solid state drive (SSD), and a communication interface for communicating with the outside. Furthermore, an input device such as a mouse or a keyboard, and an output device such as a display may be provided.

Note that the component manufacturing factory location estimation apparatus 500, the DB server 502, and the application server 503 are illustrated as separate devices here, but are not necessarily separate devices. For example, the processing may be performed using the apparatus 500, the DB server 502, and the application server 503 as one apparatus. Furthermore, for example, the DB server 502 and the application server 503 may be configured as one apparatus to perform processing. Further, each of the component manufacturing factory location estimation apparatus 500, the DB server 502, and the application server 503 may be configured by a plurality of apparatuses.

### <Data Structure>

Next, a structure of data used in the present embodiment will be described.

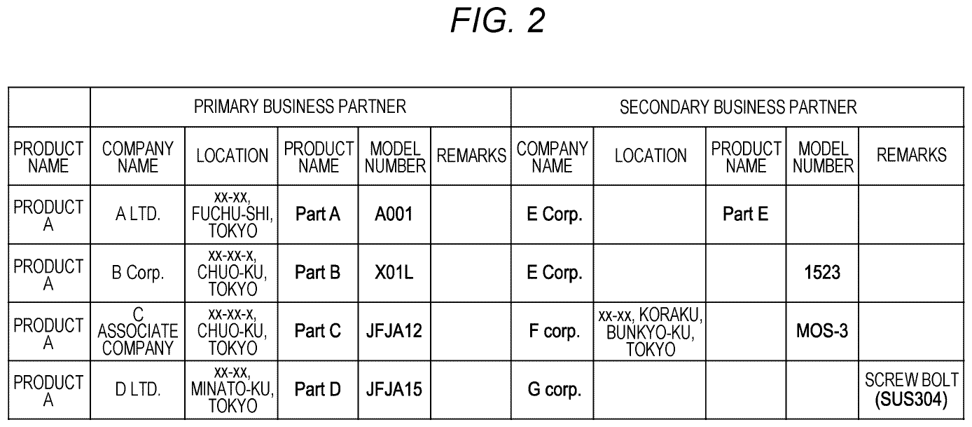

FIG. 2 is a table illustrating an example of a data table of a supplier list received as an input from a person in charge of procurement.

The supplier list is a list of information regarding suppliers of products manufactured by a company to which the person in charge of procurement belongs. The illustrated supplier list includes product names of products manufactured by the company to which the person in charge of procurement belongs. Here, the product name is product A. In addition, the supplier list includes information regarding a primary business partner and a secondary business partner as suppliers for the product A. Here, the information regarding the primary business partner and the secondary business partner includes items of a company name of a company of the supplier, a location of a head office, a component name, a model number, and remarks. In addition, the supplier list may include any item such as link information to an official home page of a company of a supplier and a company code/corporation number that can uniquely specify the company of the supplier. Then, for each item, a numerical value or text serving as data or a link to detailed data is stored in the supplier list. The definition, category, unit of value, and hierarchical structure of each item may be arbitrary as long as they follow the rules defined by the person in charge of procurement.

The supplier list may be received from the user terminal 370, or the supplier list generated by the existing system 501 may be received. Alternatively, the list may be received from a system that cooperates with the risk visualization system 1. In the present embodiment, the received supplier list is stored in the company/risk information (data lake) 301.

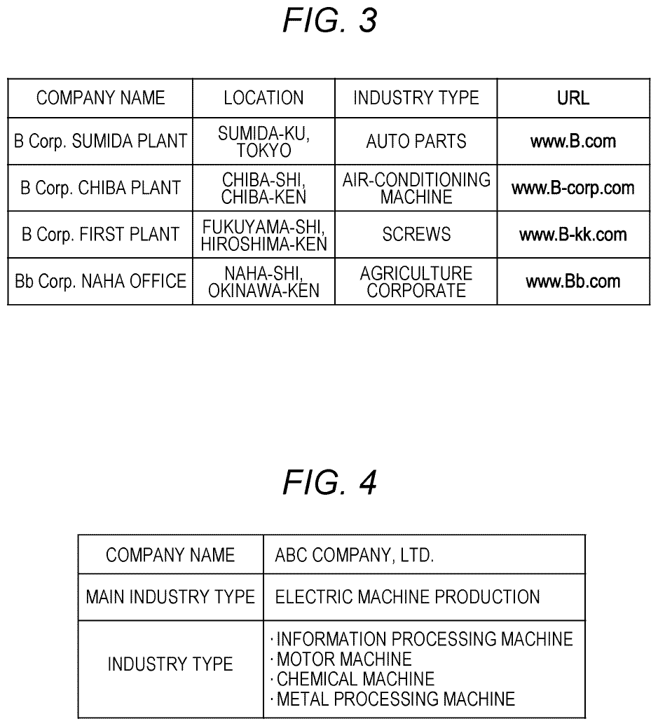

FIG. 3 is a table illustrating an example of a search result generated by the company information search unit 200 and using a company name of a supplier as a keyword.

The company information search unit 200 searches for a factory candidate of a supplier on the basis of the supplier list illustrated in FIG. 2. The company information search unit 200 searches for a factory candidate of a supplier by searching via the network 400 using a company name included in the supplier list as a keyword. As a result, it is possible to acquire factory candidates of the supplier using the supplier list. In addition, it is easier to acquire a factory candidate of a supplier by search using a company name included in the supplier list as a keyword. Here, a result of search by the company information search unit 200 using “B Corp.” in FIG. 2 as a keyword is illustrated. This search result can be treated as a list of factory candidates of the supplier. The illustrated table includes a company name, a location, industry type information, and a URL of a company's home page of a factory candidate of a supplier. Commercial data such as the company information database 300 and the open data 350 can be used for the search. Note that the search destination is not limited thereto, and information of an electronic telephone directory that can be acquired via the network 400, location information of a company registered on an online map, or the like may be used. In addition, although an example of a result of searching without distinguishing between upper and lower case letters is illustrated here, distinction between upper and lower case letters, full-width and half-width letters, and the like may be arbitrarily selected. In addition, in the following description, even in a case where description is omitted in the search processing and the matching determination processing described in the present invention, similar characters may be selectively distinguished.

FIG. 4 is a table of a data table for managing information on a company to which a person in charge of procurement belongs.

The illustrated table is a management table of a company to which the person in charge of procurement belongs. The information regarding the company includes at least a company name and an industry type. The information regarding the industry types to be registered may be registered by selecting all the industry types related to the own company. Here, the industry types are described by being classified into the main industry type and the industry types other than the main industry type. The illustrated table may be directly registered by a person in charge of procurement, or may be acquired by referring to a company information database via the network 400.

In the present embodiment, the company information illustrated in FIG. 4 is stored in the company/risk information (data lake) 301.

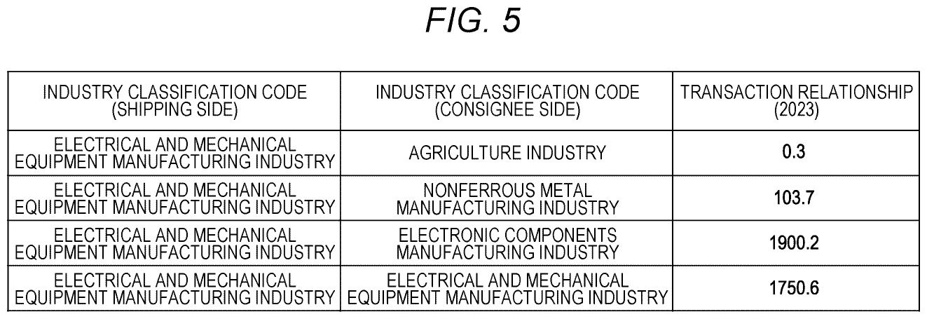

FIG. 5 is a table illustrating an example of a data table of a transaction relationship between industry types. In the illustrated table, a transaction relationship between a certain industry type and another industry type is recorded. The item representing the transaction relationship may be arbitrary, and in the present embodiment, the transaction amount in the past year is used, and the transaction amount between industries corresponding to the medium classification of the Japanese standard industrial classification is used in Japanese yen (unit: 100 million yen). That is, in the illustrated table, the transaction amount between the shipping side and the consignee side is described as the transaction relationship between a certain industry type and another industry type using the industry classification code of the medium classification of the Japanese standard industrial classification. However, the reference destination (for example, International Standard Industrial Classification, North American Industrial Classification System, and the like) of the data and the range (for example, during a single year or the last three years) of the data to be used can be arbitrarily determined. Note that, in the present embodiment, an example is illustrated in which the Japan standard industrial classification is used as data, but other data including items expressing a transaction relationship may be used.

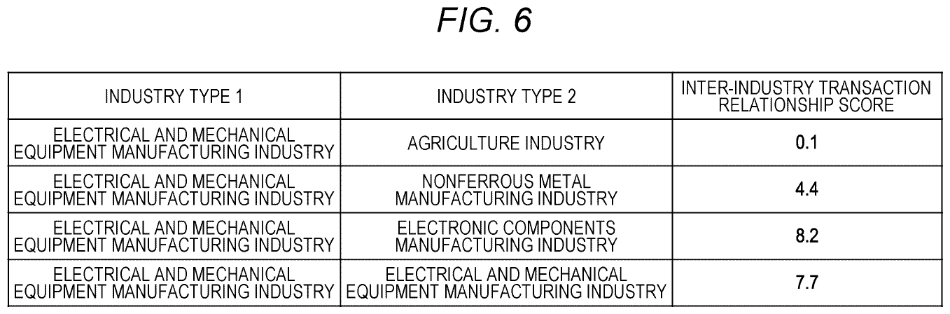

FIG. 6 is a table illustrating an example of a data table of the inter-industry transaction relationship score. The inter-industry transaction relationship score is a numerical value representing a relevance of a transaction relationship among a plurality of industry types. It is considered that the relevance of the transaction relationship is stronger as the transaction amount illustrated in FIG. 5 is larger, and weaker as the transaction amount illustrated in FIG. 5 is smaller. Therefore, the transaction relationship score calculation unit 202 calculates the inter-industry transaction relationship score on the basis of the transaction amount between the industry types. That is, in a case where the transaction amount between the respective industry types is large and the transaction relationship is large, the inter-industry transaction relationship score is high, and in a case where the transaction amount between the respective industry types is small and the transaction relationship is small, the inter-industry transaction relationship score is low. In the present embodiment, a numerical value having a maximum value of 10 calculated using the transaction amount between industries in a single year illustrated in FIG. 5 is used as the inter-industry transaction relationship score. As illustrated in FIG. 6, since the inter-industry transaction relationship score between the industry types having a large transaction amount is high, it is possible to quantitatively evaluate the product and the service scale between the industry types. In addition, here, the inter-industry transaction relationship score of the case where the industry types are the same (for example, the electric machine and appliance manufacturing industry to the electric machine and appliance manufacturing industry exemplified in the drawing) is also included. However, the inter-industry transaction relationship score is not limited thereto, and a score calculated using the transaction relationship data (for example, a transaction relationship, a transaction quantity) between the standard industrial classifications described in the comparison table between the classification items of the Japanese standard industrial classification and the industry types in the similar industry type ratio standard price calculation or the trade statistics may be used. In addition, the person in charge of procurement may input an appropriate numerical value as the inter-industry transaction relationship score.

### <Detailed Description of Component Manufacturing Factory Location Estimation Apparatus 500>

Next, the component manufacturing factory location estimation apparatus 500 will be described in detail.

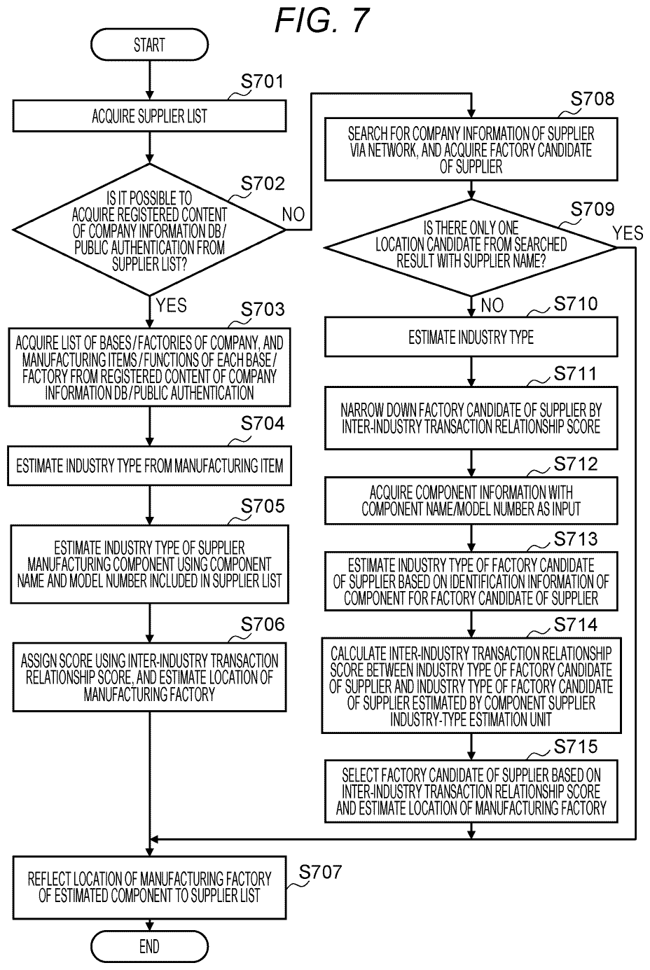

FIG. 7 is a diagram illustrating a processing flow of the component manufacturing factory location estimation apparatus 500 in the risk visualization system 1.

As illustrated in FIG. 7, the component manufacturing factory location estimation apparatus 500 first acquires a supplier list as illustrated in FIG. 2 (S701).

Next, the component manufacturing factory location estimation apparatus 500 determines whether at least one of company information and registered contents of public authentication can be acquired from the company information database 300 and the open data 350 using the company name of the supplier as a keyword (S702). In the present embodiment, a case where registered contents of public authentication information are searched will be described below. In the present embodiment, for example, registration information of ISO 9001 of the international standard is referred to. Note that the present invention is not limited thereto.

As a result, in a case where acquisition is possible (Yes in S702), the component manufacturing factory location estimation apparatus 500 acquires a list of bases/factories owned by the company that is a factory candidate of the supplier, and manufacturing items/functions of each base/factory (S703). In a case where the registration information of ISO 9001 of the international standard is referred to, it can be acquired in a format such as {“Plant A: Manufacture of square resistors”, “B factory: Manufacture of lighting fixture parts”, . . . }.

Next, the component manufacturing factory location estimation apparatus 500 estimates an industry type corresponding to the medium classification of the Japan standard industrial classification from the manufacturing items of each base and factory using the industry type estimation unit 201 (S704). In the present embodiment, for example, an estimation technique using a fine-tuned large-scale language model is applied to estimate the industry type. However, the present invention is not limited thereto, and for example, a machine learning model or the like using a past estimation result as learning data may be applied, or the industry type may be estimated by creating a correspondence table in advance. In the processing by the industry type estimation unit 201 in the present embodiment, a list of medium classifications of the Japanese standard industrial classification is given as learning data and subjected to additional learning. By inputting the manufacturing item and function of each base/factory acquired in S703 to the additionally learned large-scale language model, it is output which of the medium classifications of the Japanese standard industrial classification the business content of each base/factory corresponds to. When referring to the registration information of the international standard ISO 9001, it is estimated as {“Plant A: Electronic component/device/electronic circuit manufacturing industry”, “Plant B: Electric machine and appliance manufacturing industry”, . . . }.

Next, the component manufacturing factory location estimation apparatus 500 uses the component supplier industry-type estimation unit 204 to estimate the industry type of the supplier manufacturing the component using the component name and the model number included in the supplier list (S705). In S705, the component name and the model number are acquired from the catalog data and the Internet search via the network 400. In a case where the component name can be acquired from the catalog data, the industry type of the manufacturer who manufactures the part may be acquired as accompanying information, but in a case where the component name is acquired by Internet search, the industry type cannot be estimated. Note that, in the present embodiment, a method of estimating by using a large-scale language model additionally learned with catalog data as learning data is described as an example. The additionally learned large-scale language model receives a result acquired from catalog data or the Internet via the network 400 as an input using a component name (for example, a steel screw) or a model number (for example, AB-123) as a search keyword, and outputs an industry type (for example, metal manufacturing industry) of a supplier manufacturing the component. Note that the technology used for estimation is not limited to the large-scale language model described above, and for example, a correspondence table of component names or model numbers and industry types of suppliers may be used, or estimation may be performed using a machine learning model or the like. As a result, the industry type of each factory of the supplier estimated from the manufacturing item and the industry type of the supplier estimated from the component name and the model number can be compared in the same evaluation axis of the medium classification of the Japanese standard industrial classification.

Next, the component manufacturing factory location estimation apparatus 500 acquires the factory having the highest score by scoring the industry type of the supplier's factory estimated from the manufacturing item and the industry type of the supplier estimated from the component name and the model number using the inter-industry transaction relationship score illustrated in FIG. 6 using the component manufacturing factory estimation unit 206 (S706). Then, the location of the factory having the highest score is estimated as the location of the manufacturing factory of the component. However, the method of comparing the factory list and the function data of each factory acquired in S702 with the supplier manufacturing the component acquired in S703 is not limited to the method in S706. A determination may be used in which each word of a component name and a manufacturing item or a function of each factory is vectorized and replaced with word distributed expression such as a distance index using gestalt pattern matching or a final editing cost and cosine similarity between word vectors. Alternatively, a method of generating a factory that manufactures components using a device that receives a component name and a function list of each factory as inputs using a large-scale language model may be used. At this time, a method of improving the accuracy of generating a factory manufacturing components by causing the large-scale language model to learn in advance a systematized data table of components commonly recognized by supplier companies by the International Convention on a unified system of product names and classifications, for example, an import/export statistical item number (HS code) in the present embodiment may be used.

Then, the estimated location of the component manufacturing factory is reflected in the supplier list (S707).

In the processing of S703 to S707, in a case where the manufacturing factory of the component manufactured by the supplier has acquired the public authentication, a list of the factory location and the factory function registered in the public authentication is acquired, and the factory actually manufacturing the component is estimated from the manufacturing item of each factory, thereby estimating the location of the manufacturing factory of the component.

On the other hand, in a case where at least one of the corresponding company information and the registered content of the public authentication cannot be performed in S702 (No in S702), the component manufacturing factory location estimation apparatus 500 searches the company information of the supplier via the network 400 by the company information search unit 200, and acquires a factory candidate of the supplier (S708). The case of No in S702 is, for example, a case where information regarding a company other than the “B Corp.” in FIG. 2 can be acquired from the company information database 300 or the open data 350, but it is difficult to acquire information regarding the “B Corp.” because it is a small-scale factory. In this case, the component manufacturing factory location estimation apparatus 500 estimates the location of the manufacturing factory of the component manufactured by the supplier by the estimation method using the company information search unit 200, the industry type estimation unit 201, the transaction relationship score calculation unit 202, the component/model number estimation unit 203, the component supplier industry-type estimation unit 204, the industry type similarity calculation unit 205, and the component manufacturing factory estimation unit 206.

FIG. 3 illustrates a result of searching the company information search unit 200 for “B Corp.” as a keyword. When the search is performed by the network 400, for example, the URL of the company name, the location address, the industry type information, and the information reference source including the factory name can be acquired from the registration information of the electronic telephone book or the online map, and the corporation registration information.

Then, the company information search unit 200 determines whether there is only one factory candidate of the searched supplier (S709).

Then, in a case where there is only one location (Yes in S709), the location of the factory candidate is set as the estimation result of the location of the component manufacturing factory of the supplier, and the series of processing is terminated.

On the other hand, in a case where the factory candidates of the plurality of suppliers are searched (No in S709), the following processing is performed.

In this case, as illustrated in FIG. 3, factory candidates of a plurality of suppliers are searched. Then, the component manufacturing factory location estimation apparatus 500 first performs processing of narrowing down factory candidates of the supplier illustrated in FIG. 3 using the industry type estimation unit 201 and the transaction relationship score calculation unit 202.

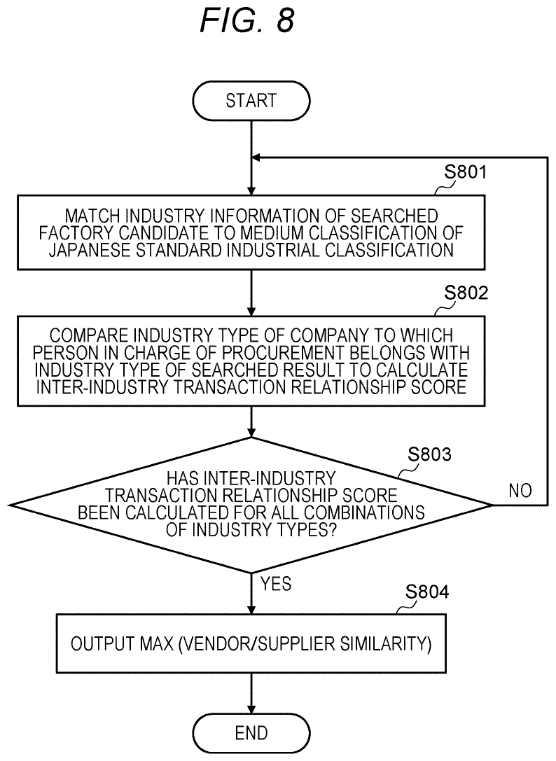

FIG. 8 is a diagram illustrating a flowchart of processing of narrowing down factory candidates of a supplier.

The industry type estimation unit 201 performs processing of matching the notation of the industry type information column in the data table of FIG. 3 with the medium classification of the Japanese standard industrial classification. In the present embodiment, the cosine similarity of the word distributed expression between the document described in the industry type information and the document described in the medium classification of the Japanese standard industrial classification is compared, and the medium classification (for example, food product manufacturing industry) of the Japanese standard industrial classification having the highest similarity is set as the industry type information. In addition, as illustrated in FIG. 4, since the information regarding the company to which the person in charge of procurement belongs is registered in advance, the information is similarly adjusted to the medium classification of the Japan standard industrial classification. The industry type “electric machine manufacturing/information processing apparatus/motor device/scientific device/metal processing machine” of ABC Company, Ltd. in FIG. 4 is estimated to be “electric machine and appliance manufacturing industry/information communication machine and appliance manufacturing industry/chemical industry/metal product manufacturing industry” which is a medium classification of Japan standard industrial classification (S801). In this case, the industry types can be compared on the same evaluation axis.

The transaction relationship score calculation unit 202 compares the industry type of the company to which the person in charge of procurement in FIG. 4 belongs with the industry type as a result of search using the “B Corp.” illustrated in FIG. 3 as a keyword, and calculates the inter-industry transaction relationship score. For example, since the annual transaction amount with the electronic component manufacturing industry, which is a component, is large in the electric machine and appliance manufacturing industry, the inter-industry transaction relationship score is high, and thus, there is a high possibility that the electric machine and appliance manufacturing industry performs transaction based on this. On the other hand, in agriculture, since the annual transaction amount with the electric machine and appliance manufacturing industry is small, the inter-industry transaction relationship score is low, and the possibility of trading with the electric machine and appliance manufacturing industry is low.

In the present embodiment, an example of matching and comparing the industry types of companies with the medium classification of the Japan standard industrial classification has been described, but the comparison of the industry types and the calculation of the score may be performed in consideration of the parent-child relationship of the classification system using the small classification item.

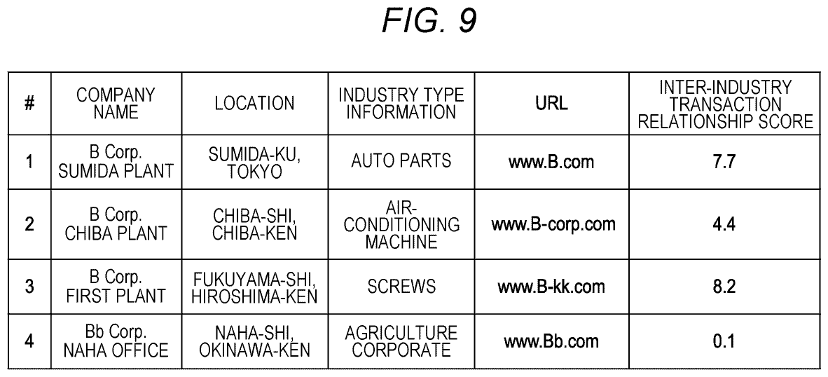

FIG. 9 is a diagram illustrating an output result of the transaction relationship score calculation unit 202.

The industry type of “B Corp. Sumida Plant” illustrated in FIG. 3 is found to be “electric machine and appliance manufacturing industry” by the industry type estimation unit 201. Referring to the data table of the calculated inter-industry transaction relationship score illustrated in FIG. 6, the inter-industry transaction relationship score of “electric machine and appliance manufacturing industry” which is the industry type of the company to which the person in charge of procurement belongs and “electric machine and appliance manufacturing industry” which is the industry type of “B Corp. Sumida Plant” is calculated to be 7.7 (S801). Since there are four industry types of the company to which the person in charge of procurement belongs, the inter-industry transaction relationship score is calculated for all combinations, and a result with the largest inter-industry transaction relationship score is determined as a calculation result (S802, S803).

In the present embodiment, an example is illustrated in which only a result in which the inter-industry transaction relationship score is the threshold (0.5) or more is used in the data table illustrated in FIG. 3. In the example of FIG. 9, “B Corp. Sumida Plant” of #1, “B Corp., Chiba Plant” of #2, and “B Corp. First Plant” of #3 are used because the threshold is 0.5 or more, but “B Corp. Naha Office” of #4 is not used because the threshold is less than 0.5. As a result, the factory candidates of the supplier illustrated in FIG. 3 are narrowed down. In this case, it is possible to narrow down the factory candidates of the supplier by focusing on the point that the industry types of the companies having a transaction relationship in the supply chain are similar. That is, in a case where the industry types are similar, the possibility of trading is high and the inter-industry transaction relationship score is high, but in a case where the industry types are not similar, the inter-industry transaction relationship score is low and the possibility of trading is low. Then, the factory candidates of the supplier are narrowed down by the inter-industry transaction relationship score. From this viewpoint, it can also be considered that the inter-industry transaction relationship score illustrated in FIG. 9 represents the business similarity between the company with the company name (in this case, “ABC Company Ltd.”) to which the person in charge of procurement in FIG. 4 belongs and the company with the company name (in this case, “B Corp.”) in FIG. 3. Note that the threshold may be read from a user definition or may be automatically changed according to the user's feedback. Furthermore, the threshold may be variable according to user's designation. In addition, the selection criteria of the result may be arbitrary, and for example, only a high-order result may be used or may be arbitrarily designated by the user.

The processing of S801 of FIG. 8 corresponds to the processing of estimating the industry type of the factory candidate of the supplier by the industry type estimation unit 201 of S710 of FIG. 7. The processing in S802 and S803 in FIG. 8 corresponds to the processing in S711 in FIG. 7 in which the transaction relationship score calculation unit 202 narrows down the factory candidates of the supplier by the inter-industry transaction relationship score between the industry type of the company to which the user belongs and the industry type of the company that is the factory candidate of the supplier.

Returning to FIG. 7, the component/model number estimation unit 203 receives a character string of a component name or a model number described in the supplier list as an input, and acquires component information via the network 400 (S712). As described above, the component information corresponds to, for example, a material, a price, a delivery date, and the like of the component. In the present embodiment, for example, the online component catalog and the component information database are referred to as the search target. However, as the search target, an Internet search result acquired via the network 400 may be used, or a database in an organization to which the person in charge of procurement belongs may be used. In addition, by storing the search results of the component names or model numbers in the company/risk information (data lake) 301, the search results may be used for the next and subsequent searches.

Next, the component supplier industry-type estimation unit 204 estimates the industry type of the factory candidate of the supplier on the basis of the identification information of the component for the factory candidate of the supplier (S713).

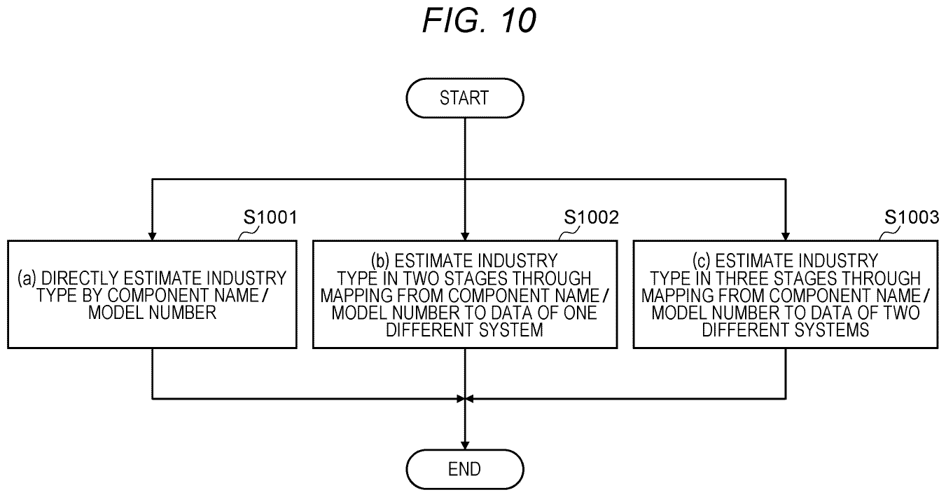

FIG. 10 is a diagram illustrating an outline of a processing flow of the component supplier industry-type estimation unit 204.

The component supplier industry-type estimation unit 204 is a processing unit that estimates which candidate is likely to be the supplier company among the search results using the company name of the factory candidate of the supplier as the keyword generated by the company information search unit 200 illustrated in FIG. 3. The component supplier industry-type estimation unit 204 estimates an industry type of a factory candidate of the supplier on the basis of at least one (hereinafter, it may be simply referred to as “component name/model number”) of the component name and the model number as the identification information of the component. In the present embodiment, the component supplier industry-type estimation unit 204 performs estimation using data of three different systems in order to estimate the industry type of the supplier manufacturing the component from the information of the component name/model number. Here, the component supplier industry-type estimation unit 204 performs estimation by three methods of (a) direct estimation of industry type by component name/model number (S1001), (b) estimation of industry type in two stages through mapping from component name/model number to data of one different system (S1002), and (c) estimation of industry type in three stages through mapping from component name/model number to data of two different systems (S1003). As a result, it is possible to perform estimating by combining a plurality of pieces of data on the basis of the component name/model number, and it is possible to estimate the industry type with a plurality of ideas.

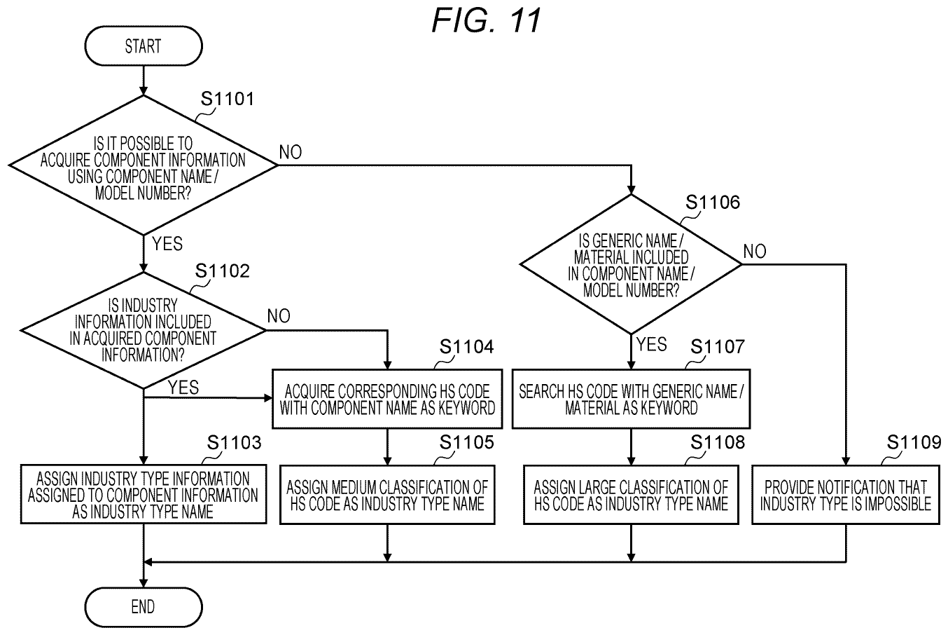

FIG. 11 is a diagram illustrating details of a processing flow of the component supplier industry-type estimation unit 204.

In the present embodiment, the component/model number estimation unit 203 determines whether component information can be acquired from the Internet or a component catalog via the network 400 using the component name/model number as a keyword (S1101).

Then, in a case where the component information can be acquired from the component catalog or the Internet (Yes in S1101), the component supplier industry-type estimation unit 204 determines whether the industry type information of the supplier is assigned as the component information in addition to, for example, information such as a material, a price, and a delivery date of the component (S1102).

As a result, in a case where the industry type information of the supplier is assigned (Yes in S1102), the component supplier industry-type estimation unit 204 uses the acquired industry type information as it is as the industry type name of the supplier (S1103). In the present embodiment, in a case where the industry type information of the supplier is assigned (Yes in S1102), the processing of S1104 is also performed together with S1103.

On the other hand, in a case where the industry type information of the supplier is not assigned (No in S1102), the component supplier industry-type estimation unit 204 acquires the corresponding HS code with the component name as a keyword (S1104). In the present embodiment, the present function is realized using a large-scale language model that receives a component name as an input and generates a corresponding HS code. However, the present invention is not limited to this method, and for example, a correspondence table between a component name and an HS code may be used, or the HS code may be cooperated with an external service capable of searching for the HS code from the component name.

Then, the medium classification name in the HS code is used as the industry type name of the supplier (S1105).

On the other hand, there is a case where the component information cannot be acquired from the component catalog or the Internet in S1101 (No in S1102). This applies, for example, when the component is a unique model number, a special order, or the like. In this case, the component supplier industry-type estimation unit 204 confirms whether the generic name (for example, a standard name such as “M5”, “hexagonal bolt”, or the like) or the material (for example, “SUS 304”, “brass”, or the like) is included in the component name/model number (S1106).

In a case where the generic included (Yes in S1106), the component supplier industry-type estimation unit 204 acquires the corresponding HS code with the generic name/material as a keyword (S1107). In the present embodiment, the present function is implemented using a large-scale language model that receives a generic name/material as an input and generates a corresponding HS code.

Then, the large classification name in the HS code is used as the industry type name of the supplier (S1108).

In a case where the generic name/material is not included in the component name/model number in S1106 (No in S1106), the estimation of the industry type is impossible, and thus, the component supplier industry-type estimation unit 204 notifies the user terminal 370 that the estimation of the industry type is impossible via the network 400 (S1109).

In the industry type estimation flow of FIG. 11, the component supplier industry-type estimation unit 204 performs at least one of directly estimating the industry type of the factory candidate of the supplier from the component name/model number and estimating the industry type via mapping to data of a different system. In this case, the estimation can be performed by combining a plurality of pieces of data based on the component name/model number. Then, in a case where the component information can be acquired, the component supplier industry-type estimation unit 204 directly estimates the industry type of the factory candidate of the supplier from the component name/model number, and in a case where the component information cannot be acquired, the component supplier industry-type estimation unit estimates the industry type through mapping to data of a different system. In this case, even when the industry type of the factory candidate of the supplier cannot be directly estimated on the basis of the component name/model number, it can be estimated by another method.

In addition, the processing flow of the component supplier industry-type estimation unit 204 in FIG. 11 is one of whether two estimation results of S1103 and S1105 are obtained, one estimation result of S1105 and S1108 is obtained, and estimation of the industry type in S1109 is impossible. That is, the number of estimation results of the industry type is any one of 0, 1, and 2.

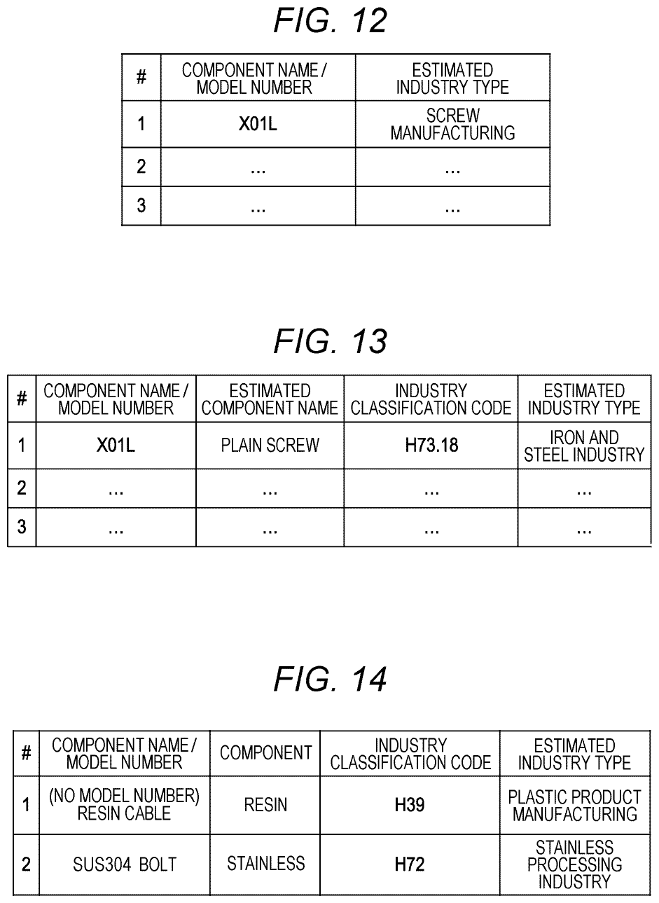

FIG. 12 is a diagram illustrating a data table illustrating an estimation result when (a) the industry type is directly estimated by a component name/model number.

The illustrated data table includes items of a component name, a model number, and an estimated industry type. Here, there is one corresponding to the company information database 300 with the model number “X01L” as a keyword, and the result of directly estimating the industry type is illustrated. It is indicated that the estimated industry type is “screw manufacturing” for the component with the component name and model number of “X01L”.

Note that, in the present embodiment, the component name/model number is used as a keyword, but the present invention is not limited thereto, and any information may be used as long as the information can uniquely specify the transaction item. For example, in a case where the component information can be searched from the component information database or the online catalog, the industry type included in the property information is assigned as the estimation result using the fact that the property information including the industry type is assigned to each component.

FIG. 13 is a diagram illustrating a data table illustrating an estimation result when (b) the industry type is estimated in two stages through mapping from the component name/model number to data of one different system.

The illustrated data table includes items of a component name and a model number, an estimated product name, an industry classification code, and an estimated industry type. In the present embodiment, the component name/model number is used as a keyword, but the present invention is not limited thereto, and any information may be used as long as the information can uniquely specify the transaction item. In a case where the industry type information is not described in the component information database or the online catalog, the component supplier industry-type estimation unit 204 converts the data into data of different systems using the category to which the component belongs and the tag information (for example, screw/bolt>steel iron screw>plain screw>X01L), and estimates the industry type of the supplier manufacturing the component. In the present embodiment, an example is shown in which a category to which a component belongs is acquired from a component name/model number, and an industry type is estimated via an import/export statistical item number (HS code) which is data of a different system. By using the HS code, it becomes easier to estimate the industry type of the factory candidate of the supplier. “X01L” is estimated as the product name “plain screw”, but it is difficult to estimate the medium classification of the Japan standard industrial classification from the keyword of “plain screw”. Therefore, by converting the “steel screw” into the corresponding HS code “H73.18”, it is possible to estimate the “iron and steel industry” which is the medium classification of the Japanese Standard Industrial Classification corresponding to the HS code “H73.18”. That is, in this case, the supplier industry type name is estimated by a two-stage configuration of component name/model number-HS code-industry type. That is, the industry type is estimated from the component name through two mappings. In the present embodiment, the information in which the item is estimated is used as the data of the different system, but the present invention is not limited thereto. For example, reference may be made to international standards, industry standards, and the like.

FIG. 14 is a diagram illustrating a data table illustrating an estimation result when (c) the industry type is estimated in three stages through mapping from the component name/model number to data of two different systems.

The illustrated data table includes items of a component name and a model number, a component, an industry classification code, and an estimated industry type. In the present embodiment, the component name/model number is used as a keyword, but the present invention is not limited thereto, and any information may be used as long as the information can uniquely specify the transaction item. In the column of the component name or the model number of the supplier list, there may be a description that information cannot be acquired from the component information database or the online catalog. For example, in a case where there is no model number such as a unique model number or a customized product with which a component is associated only in a company of a supplier, in this case, a material or a generic name of the component such as “resin cable” or “SUS304 volt” is described in a column of a component name or a model number of a supplier list. FIG. 14 illustrates an example in which “no model number” is indicated, information regarding similar components is acquired from materials and generic names of the components, categories to which similar components belong are acquired, and industry types are estimated via HS codes which are data of different systems. In the present embodiment, the component supplier industry-type estimation unit 204 performs the HS code search with the generic name/material as a keyword using a large-scale language model (S1106 and S1107 in FIG. 11). Then, the component supplier industry-type estimation unit 204 assigns the large classification name of the HS code as the supplier industry type name (S1108 in FIG. 11). That is, in this case, the supplier industry type name is estimated by a three-stage configuration of component name/model number-constituent material-HS code-industry type. That is, the industry type is estimated from the component name through three mappings. However, the present invention is not limited to this estimation method. For example, the supplier industry type name may be estimated by a three-stage configuration of component name/model number-generic name-HS code-industry type.

In addition, in a case where only the unique model number is described in the supplier list and there is no keyword such as a material name that can be searched, it is determined that the industry type name cannot be estimated, and a feedback is sent to the person in charge of procurement (S1109). However, the data through which the industry type is estimated from the component name/model number is not limited to the data referred to in the present embodiment, and for example, trade statistical data such as Standard International Trade Classification (SITC code) or BEC code or a classification system unique to the industry may be used. In addition, input of a person in charge of procurement may be accepted.

Returning to FIG. 7, the industry type similarity calculation unit 205 calculates an inter-industry transaction relationship score between the industry type of the factory candidate of the supplier and the industry type of the factory candidate of the supplier estimated by the component supplier industry-type estimation unit 204 (S714). That is, the industry type similarity calculation unit 205 calculates the inter-industry transaction relationship score between the industry type estimated from the industry type information of FIG. 3 using the industry type estimation unit 201 and the industry type estimated by the processing flow of the component supplier industry-type estimation unit 204 of FIG. 11.

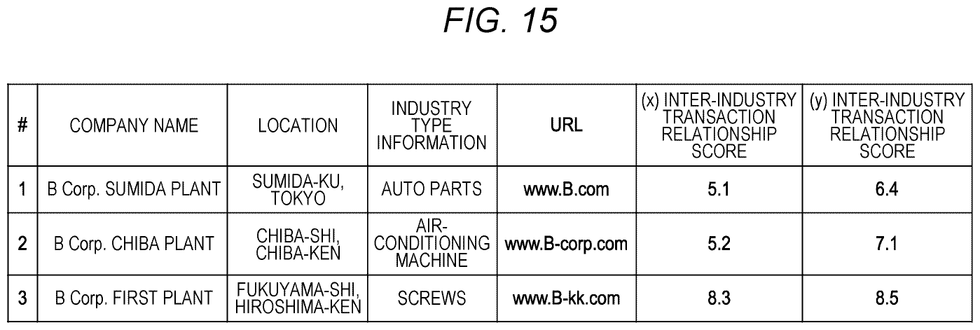

FIG. 15 is a diagram illustrating a data table when the inter-industry transaction relationship score is assigned to the search result of FIG. 3.

FIG. 15 is expressed as a table in which the inter-industry transaction relationship score is added to the search result using the supplier name illustrated in FIG. 3 as a keyword. However, as described in FIG. 9, since the processing of narrowing down the factory candidates of the supplier illustrated in FIG. 3 is performed using the industry type estimation unit 201 and the transaction relationship score calculation unit 202, “B Corp. Naha Office” of #4 is not included. FIG. 15 illustrates a case where the result of (x) direct estimation of the industry type by component name/model number (estimation result of (a) above) and the result of (y) estimation of the industry type from component name/model number via data of a different system (estimation result of (b) above) can be acquired. The result of (x) direct estimation of the industry type by component name/model number is obtained by calculating the inter-industry transaction relationship score using the industry type assigned in S1103 of FIG. 11. Similarly, the result of (y) estimation of the industry type from component name/model number via data of a different system is obtained by calculating the inter-industry transaction relationship score using the industry type assigned by S1105 of FIG. 11.

Returning to FIG. 7 again, the component manufacturing factory estimation unit 206 selects a factory candidate of the supplier on the basis of the inter-industry transaction relationship score calculated by the industry type similarity calculation unit 205, and estimates the location of the selected supplier candidate as the location of the manufacturing factory of the component manufactured by the supplier (S715).

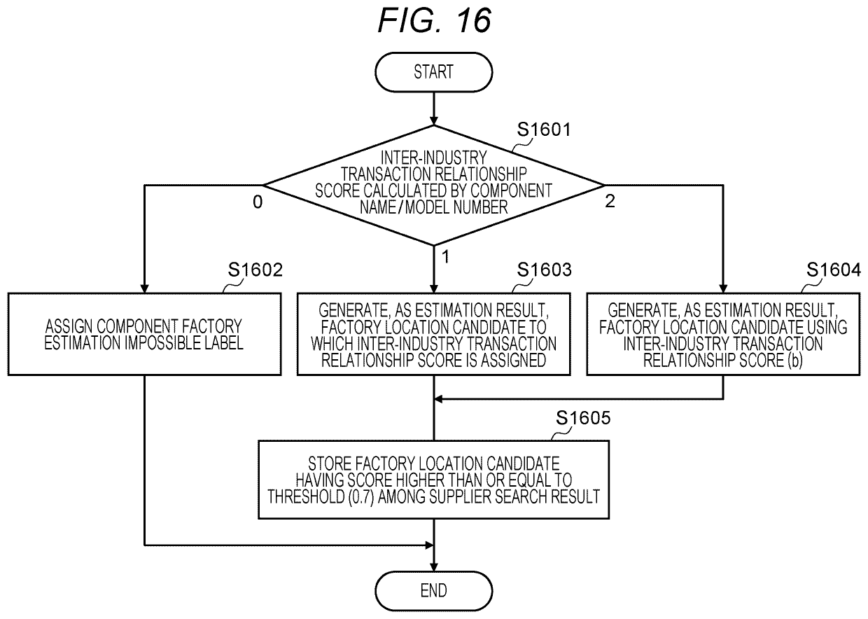

FIG. 16 is a diagram illustrating a processing flow of the component manufacturing factory estimation unit 206. As described with reference to FIG. 11, the number of estimation results of the industry type is any one of 0, 1, and 2. The component manufacturing factory estimation unit 206 determines the number of estimation results of the industry type (S1601), and performs the processing of S1602, S1603, and S1604, respectively.

In a case where no inter-industry transaction relationship score can be estimated (in a case where the number of industry type estimation results is 0), the component manufacturing factory estimation unit 206 assigns a component factory estimation impossible label (S1602).

In a case where one inter-industry transaction relationship score can be estimated (in a case where the number of industry type estimation results is 1), the component manufacturing factory estimation unit 206 generates the address of the supplier candidate to which the inter-industry transaction relationship score is assigned as the estimation result of the factory location candidate of the supplier company (S1603).

In a case where two inter-industry transaction relationship scores can be estimated (in a case where the number of industry type estimation results is 2), the component manufacturing factory estimation unit 206 generates a factory candidate of the supplier having the inter-industry transaction relationship score which is maximum in the estimation of method (b) as the estimation result of the factory location candidate of the component manufactured by the supplier (S1604). This can also be said that the component manufacturing factory estimation unit 206 selects a factory candidate of the supplier having the maximum inter-industry transaction relationship score, and estimates the location of the factory candidate of the selected supplier as the location of the manufacturing factory of the component manufactured by the supplier. As a result, it is possible to present, to the user, the location having the highest possibility as the location of the factory candidate of the supplier.

Then, the component manufacturing factory estimation unit 206 stores the case where the inter-industry transaction relationship score is higher than or equal to the threshold (for example, 0.7) as a factory location candidate of the supplier company (S1605). It can also be said that the component manufacturing factory estimation unit 206 further selects a factory candidate of a supplier equal to or more than a predetermined threshold (in this case, 0.7). This allows the user to select a correction candidate even in a case where the estimation result is wrong.

However, the priority order and combination of the inter-industry transaction relationship scores for estimating the component manufacturing factory are not limited to the definition of the present embodiment, and may be defined using, for example, a weighted average or a predefined weighting factor.

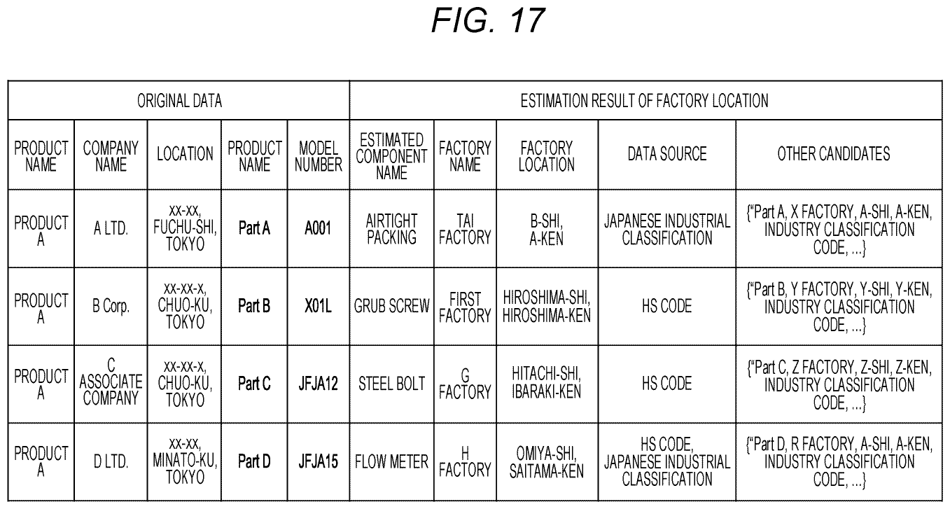

FIG. 17 is a diagram illustrating a data table when the location of the component manufacturing factory estimated in S707 of FIG. 7 is reflected in the supplier list.

In the present embodiment, a case where the estimation result of the location of the component manufacturing factory is assigned to the supplier list illustrated in FIG. 2 is illustrated. As illustrated in FIG. 17, in the present embodiment, an estimated component name, a factory name, a factory location, a data source, and other candidate columns are assigned to the original data. However, the column to be assigned is not limited to the illustrated form. In the other candidate column, a list of factory candidates of the supplier whose inter-industry transaction relationship score is equal to or more than the threshold is illustrated. Accordingly, even in a case where the estimation result is wrong, the person in charge of procurement can select a correction candidate from the list. In the present embodiment, an example is illustrated in which about the top five inter-industry transaction relationship scores can be acquired by setting the threshold to 0.7. This threshold may be defined in advance, or the threshold may be dynamically generated in a variable manner so that about the top five inter-industry transaction relationship scores are selected.

In the processing flow of FIG. 7, it can be said that in a case where the supplier included in the supplier list has not acquired the public authentication (No in S702), the company information search unit 200 searches for a factory candidate of the supplier (S708), and in a case where the supplier has acquired the public authentication, the industry type of the factory of the supplier is estimated from the manufacturing item registered in the public authentication (S704). As a result, in a case where the supplier has acquired the public authentication, the industry type of the factory of the supplier can be estimated on the basis of the public authentication, and even in a case where the supplier has not acquired the public authentication, the company information search unit can search for the factory candidate of the supplier to estimate the industry type of the factory of the supplier.

According to the embodiment described in detail above, it is possible to provide the component manufacturing factory location estimation apparatus 500 capable of estimating the location of the component manufacturing factory manufactured by the supplier. In this case, the location of the manufacturing factory of the missing part can be automatically assigned to the supplier list. In addition, by reducing the number of man-hours related to information collection of the person in charge of procurement, it is possible to quickly determine a risk for the supply chain. Then, by combining data of different uses and estimating the location of the manufacturing factory in multiple stages, estimation with a plurality of ideas can be performed.

In the embodiment described above, the names of the company information search unit 200, the industry type estimation unit 201, the transaction relationship score calculation unit 202, the component/model number estimation unit 203, the component supplier industry-type estimation unit 204, the industry type similarity calculation unit 205, and the component manufacturing factory estimation unit 206 are used as functional units of the component manufacturing factory location estimation apparatus 500. However, these names are used for convenience, and the functions are not limited to the functions according to these names. In addition, other names can be used. For example, the factory candidate search unit 200, the first industry type estimation unit 201, the first score calculation unit 202, the component information search unit 203, the second industry type estimation unit 204, the second score calculation unit 205, the location estimation unit 206, and the like may be used.

### <Description of Information Processing Method>

The processing performed by the component manufacturing factory location estimation apparatus 500 is realized by cooperation of software and hardware resources. That is, a processor such as a CPU provided in the apparatus 500 loads a program for realizing each function of the component manufacturing factory location estimation apparatus 500 into the main memory and executes the program to realize each function.

Therefore, the processing performed by the component manufacturing factory location estimation apparatus 500 described above can be grasped as an information processing method in which the processor executes the program recorded in the memory to execute: calculating an inter-industry transaction relationship score indicating the relevance of the transaction relationship between the plurality of industry types; estimating, for the factory candidate of the supplier, the industry type of the factory candidate of the supplier from the component; calculating an inter-industry transaction relationship score between the industry type of the factory candidate of the supplier and the estimated industry type of the factory candidate of the supplier; selecting a factory candidate of the supplier on the basis of the calculated inter-industry transaction relationship score; and estimating the location of the selected supplier candidate as the location of the manufacturing factory of the component manufactured by the supplier. As a result, it is possible to provide an information processing method capable of estimating the location of the manufacturing factory of the component manufactured by the supplier.

In addition, the program operating in the component manufacturing factory location estimation apparatus 500 can be grasped as a program for causing a computer to realize: a function of calculating an inter-industry transaction relationship score indicating a relevance of a transaction relationship between a plurality of industry types; a function of estimating, for a factory candidate of a supplier, an industry type of the factory candidate of the supplier from a component; a function of calculating an inter-industry transaction relationship score between an industry type of the factory candidate of the supplier and the estimated industry type of the factory candidate of the supplier; and a function of selecting a factory candidate of the supplier on the basis of the calculated inter-industry transaction relationship score and estimating a location of the selected supplier candidate as a location of a manufacturing factory of a component manufactured by the supplier. As a result, a function of estimating the location of the manufacturing factory of the component manufactured by the supplier can be realized by the computer.

Note that the program for realizing the present embodiment can be provided not only by means of communication but also by being stored in a recording medium such as a CD-ROM.

What is claimed is:

1. An information processing apparatus comprising:
a transaction relationship score calculation unit that calculates an inter-industry transaction relationship score indicating a relevance of a transaction relationship among a plurality of industry types;
a component supplier industry-type estimation unit that estimates an industry type of a factory candidate of a supplier on a basis of identification information of a component for a factory candidate of a supplier;
an industry type similarity calculation unit that calculates an inter-industry transaction relationship score between an industry type of a factory candidate of a supplier and an industry type of a factory candidate of a supplier estimated by the component supplier industry-type estimation unit; and
a component manufacturing factory estimation unit that selects a factory candidate of a supplier on a basis of an inter-industry transaction relationship score calculated by the industry type similarity calculation unit, and estimates a location of the selected supplier candidate as a location of a manufacturing factory of a component manufactured by a supplier.

2. The information processing apparatus according to claim 1, wherein the transaction relationship score calculation unit narrows down factory candidates of a supplier by an inter-industry transaction relationship score between an industry type of a company to which a user belongs and an industry type of a factory candidate of a supplier, and sets the narrowed-down factory candidates as a processing target of the component supplier industry-type estimation unit.

3. The information processing apparatus according to claim 2, further comprising an industry type estimation unit that estimates an industry type of a factory candidate of a supplier.

4. The information processing apparatus according to claim 1, wherein the component supplier industry-type estimation unit performs at least one of direct estimation of an industry type of a factory candidate of a supplier from at least one of a component name and a model number and estimation via mapping to data of a different system.

5. The information processing apparatus according to claim 4, further comprising a component/model number estimation unit that acquires component information,
wherein in a case where the component supplier industry-type estimation unit can acquire the component information, the component supplier industry-type estimation unit directly estimates an industry type of a factory candidate of a supplier from at least one of a component name and a model number, and in a case where the component supplier industry-type estimation unit cannot acquire the component information, the component supplier industry-type estimation unit performs estimation via mapping to data of a different system.

6. The information processing apparatus according to claim 4, wherein the data of the different system includes an import/export statistical item number.

7. The information processing apparatus according to claim 1, further comprising a company information search unit that searches for a factory candidate of a supplier on a basis of a supplier list that is a list of information associated with a supplier of a product manufactured by a company to which a user belongs.

8. The information processing apparatus according to claim 7, wherein the company information search unit searches for a factory candidate of a supplier by searching for a company name of a supplier included in the supplier list as a keyword.

9. The information processing apparatus according to claim 7, wherein the company information search unit searches for a factory candidate of a supplier in a case where a supplier included in the supplier list has not acquired public authentication, and estimates an industry type of a factory of a supplier from a manufacturing item registered in the public authentication in a case where the supplier has acquired the public authentication.

10. The information processing apparatus according to claim 1, wherein the component manufacturing factory estimation unit selects a factory candidate of a supplier having a maximum inter-industry transaction relationship score, and estimates a location of the selected factory candidate of the supplier as a location of a manufacturing factory of a component manufactured by the supplier.

11. The information processing apparatus according to claim 10, wherein the component manufacturing factory estimation unit further selects a factory candidate of a supplier equal to or more than a predetermined threshold.

12. The information processing apparatus according to claim 1, wherein the transaction relationship score calculation unit calculates an inter-industry transaction relationship score on a basis of a transaction amount between industry types.

13. An information processing method performed by a processor that executes a program recorded in a memory, the method comprising:
calculating an inter-industry transaction relationship score indicating the relevance of a transaction relationship between a plurality of industry types;
estimating, for a factory candidate of a supplier, an industry type of the factory candidate of the supplier from a component;
calculating an inter-industry transaction relationship score between an industry type of a factory candidate of a supplier and the estimated industry type of the factory candidate of the supplier;
selecting a factory candidate of a supplier on a basis of the calculated inter-industry transaction relationship score; and
estimating a location of the selected supplier candidate as a location of a manufacturing factory of a component manufactured by the supplier.
